(19) United States
(12) Patent Application Publication
(10) Pub. No.: US 2022/0011118 A1
(43) Pub. Date: Jan. 13, 2022

(54) Systems and Methods for Map Matching

(71) Applicant: Bayerische Motoren Werke Aktiengesellschaft, Muenchen (DE)

(72) Inventors: Bastian BEGGEL, Saarbruecken (DE); Stefan HOLDER, Muenchen (DE)

(21) Appl. No.: 17/295,968

(22) PCT Filed: Nov. 28, 2019
(86) PCT No.: PCT/EP2019/082993

§ 371 Date: May 21, 2021

(30) Foreign Application Priority Data
Nov. 30, 2018 (DE) 10 2018 130 457.9

(51) Int. Cl. G01C 21/30; G01C 21/00; G06N 7/00

(52) U.S. Cl. CPC G01C 21/30; G06N 7/005; G01C 21/38

(57) ABSTRACT

A method for determining a map matching confidence includes detecting a trajectory; detecting network data containing a plurality of links of a network; detecting one or more data pairs, each of said one or more data pairs including a link from the plurality of links and a time window that captures at least one portion of the trajectory; determining, for each of the one or more data pairs, a map matching confidence for the link of the relevant data pair based on: determining a maximum a posteriori probability; or determining by using a modified forward algorithm, wherein the map matching confidence is designed to indicate a probability that the relevant link has been affected by the trajectory within the relevant time window.

### BACKGROUND AND SUMMARY OF THE INVENTION

The disclosure relates to systems and methods for calculating a map matching confidence. The disclosure relates in particular to systems and methods for calculating a map matching confidence when using map data in motor vehicles.

Map matching methods for mapping a sequence of GPS positions on map data are known in the related art, which are to relatively improve an accuracy of the mapping, for example of positions of a vehicle on corresponding road connections. In map matching, a sequence of GPS positions is thus typically mapped on a road network. It is determined for each GPS position on which road the vehicle is driving.

A road network, for example, as described in Newson, Paul, and John Krumm: “Hidden Markov map Matching through noise and sparseness.”, Proceedings of the 17th ACM SIGSPATIAL international conference on advances in geographic information systems, ACM, 2009, can be modeled as a graph which can consist of both directed and also undirected edges. In contrast to the publication of Newson and Krumm, a directed edge does not necessarily have to mean a one-way road, since roads which can be traveled in both directions can also be modeled as two directed edges. Each edge has a description of its geometry, for example as a polyline (i.e., as a line which is composed of multiple segments). Map producers offer maps in different formats using different models. Thus, in some models links can only end at intersections or there are only directed edges. The above-mentioned model represents the most general case, however.

Newson and Krumm describe a map matching method based on the hidden Markov model (HMM). This method calculates the most probable sequence of links over which the vehicle is driven with the aid of the Viterbi algorithm. In this case, each GPS position is mapped on a so-called matching, the combination of link and position is mapped on the link (in short <link, position on link>). The position on a link can be produced, for example, as a fraction, i.e., as a number between 0 and 1.

In addition to the mapping of GPS positions on the road network, the HMM map matching of Newson and Krumm does not calculate a confidence measure as to whether the GPS positions are actually located on the matched links. A map matching confidence can be used, for example, to decide whether a recognized hazardous situation is to be relayed to other vehicles.

Document U.S. Pat. No. 5,774,824 describes, for example, a map adaptation navigation system for monitoring vehicle state properties, including the location of a vehicle on a map route. The map adaptation navigation system can operate in a fixed mode in which the map route is input by a user, or in a flexible mode, in which the map adaptation navigation system determines the map route from a plurality of measured points which correspond to the location of the vehicle. The map adaptation navigation system additionally updates the location of the vehicle at a plurality of positions on the map route, wherein the vehicle location is known, with an elevated trust level.

The document describes a related art map matching method and can therefore be considered to be a possible alternative to the method of Newson and Krumm. Within the method, probabilities/confidences for route alternatives are calculated, however, only to select route sections having high confidence for the purpose of the map matching (similarly to Newson and Krumm). A confidence as to whether a route section would be traveled within a time window is not calculated.

In general, local hazards, for example accidents or black ice, can be recognized via vehicle sensors (for example, airbag, driving dynamics sensors) and transmitted via a backend connection to other vehicles. For this purpose, the vehicles transmit a sequence of GPS positions (for example, 10 GPS positions before and 10 GPS positions after the detection of a hazardous situation) to the backend. In the backend, this sequence of positions is mapped by a map matcher on the road network. The transmission of multiple GPS positions instead of only one GPS position is used to improve the accuracy of the map matching. With the aid of the map matching, the accurate position of the local hazards on the road can thus be determined and other vehicles can be warned of the hazard with the most accurate possible position specification.

There can be cases in which the accurate position of the hazard, in particular the road link with the hazard, may not be unambiguously determined from the sequence of the GPS positions. If the local hazard is located on an adjacent, incorrect road and transmitted with this incorrect position to further vehicles, this has the result that the position of the hazard is displayed incorrectly in following vehicles. Further consequences can be that vehicles are warned about hazards which are not relevant to them (so-called false positives), and that vehicles are not warned of hazards although they are relevant to them (so-called false negatives).

In particular false positives may be reduced by a map matching confidence. The prior art does not deal with the fact that existing map matching algorithms do not calculate a confidence for the map matching result, in particular not a probability with which a link would be driven through.

There is therefore a demand for systems and methods for calculating a map matching confidence which provide improved accuracy and reliability.

In contrast to related art methods, which are oriented to online map matching in the vehicle, in the presently disclosed systems and methods, offline map matching in the backend is in the foreground. The latter can, in contrast to online map matching, use the entire GPS trajectory, which leads in particular to better results for both the map matching and also for the confidence calculation. Furthermore, the presently disclosed systems and methods are also applicable for online map matching in the vehicle.

Two types of offline map matching can be differentiated here. Map matching of longer trip sections or of complete trips (so-called trace map matching) and map matching of short trip sections (for example, 10 or 20 positions, so-called mini-trace map matching).

Mini-trace trap matching combines the advantages of offline map matching (higher accuracy due to additional positions before and after a position to be matched) and online map matching (up-to-date results are obtained and it is not necessary to wait until the end of the trip). Eventual worsening of the accuracy in relation to map matching of complete trips is typically only insignificant, since, for example, 10 positions before and after an event are sufficient for the processing.

In the case of non-time-critical applications, it is possible, for example, to observe 10 positions before and 10 positions after an event. In the case of time-critical applications, for example, only 10 positions before an event would be considered. An improved accuracy over online map matching is then typically not to be expected.

The systems and methods according to the present disclosure are essentially oriented to trace map matching and mini-trace map matching.

All three of the above-mentioned types of matching (i.e., trace, mini-trace, and online map matching) can be carried out both in the vehicle and also in the backend, wherein preferably offline map matching for complete trips and mini-trace matching are used in the backend. In contrast, online map matching is preferably used in the vehicle.

It is an object of the present disclosure to provide systems and methods for calculating a map matching confidence, which avoid one or more of the above-mentioned disadvantages and/or enable one or more of the described advantages.

It is in particular an object of the present disclosure to provide systems and methods for calculating a map matching confidence which offer improved accuracy and reliability.

In particular by selecting a suitable minimum confidence for a matched link, for example of a recognized local hazard, according to an embodiment of the invention the number of cases may thus be reduced in which vehicles are warned of hazards although they are not relevant to them (so-called false positives).

The advantages of the present disclosure of the calculation of a map matching confidence are not only, however, in the locating of local hazard warnings. Thus, many applications which use a map matcher can draw advantages from a map matching confidence. Further examples of map matching applications are:

The extraction of items of traffic flow information from GPS trajectories.

The association of attributes which were recognized by sensors or reported by users to road links (for example, recognized traffic signs).

The automated derivation of traffic rules (for example, no left turn) from GPS trajectories.

HMM-based map matching uses the topology and geometry of the road network and the entire sequence of the GPS positions to determine the most probable sequence of links. The presently disclosed systems and methods for calculating the map matching confidence are therefore based on a refinement of HMM-based map matching.

The above-mentioned object is achieved by the claimed invention.

In a first aspect according to embodiments of the present disclosure, a method for calculating a map matching confidence is specified. The method comprises: capturing a trajectory; capturing network data containing a plurality of links of a network; capturing one or more data pairs, wherein each of the one or more data pairs contains: a link (1) from the plurality of links; and a time window (w), which captures at least a part of the trajectory. The method furthermore comprises determining, for each of the one or more data pairs, a map matching confidence (c(l,w)) for the link (l) of the respective data pair based on: determining a maximum a posteriori probability; or determining by using a modified forward algorithm, wherein the map matching confidence is configured to specify a probability that the trajectory has been tangent to the respective link (l) within the respective time window (w).

In a second aspect according to preceding aspect 1, the trajectory contains a plurality of position specifications. Each position specification of the plurality of position specification contains: a GPS position and a timestamp.

In a third aspect according to preceding aspect 2, the method furthermore comprises determining: one or more matching candidates for each position specification, preferably in the form of a pair made up of the link (l) of a data pair and a position on the link (l); an observation probability for each of the one or more matching candidates of each position specification based on a distance of the position specification from the link (l) of the matching candidates; and a transition probability in pairs for each of the one or more matching candidates with respect to a first position specification (P1) and a second position specification (P2) adjacent to the first position specification, wherein the transition probability is determined from each matching candidate of the first position specification to each matching candidate of the second position specification.

In a fourth aspect according to either one of preceding aspects 2 or 3, the method furthermore comprises determining each time window (w) of the one or more data pairs based: on the entire trajectory, if the trajectory does not exceed a predetermined duration, preferably wherein the predetermined duration is less than 60 seconds, more preferably less than 30 seconds; on an interval between n position specifications before and k position specifications after a reference position specification, preferably wherein n, k are less than 10; on a time interval before and after a reference position specification, preferably wherein the time interval is less than 30 seconds, furthermore preferably less than 15 seconds; or a ratio between a position specification and the corresponding link (l) of the respective data pair, wherein the ratio of the position specification to the corresponding link (l) is defined in that the corresponding link (l) is a candidate for the position specification.

In a fifth aspect according to any one of preceding aspects 1 to 4 in conjunction with aspect 3, determining a maximum a posteriori probability comprises: determining a respective a posteriori probability for each link (l) of a data pair based on the respective observation probability and the respective transition probability and determining the maximum a posteriori probability based on the maximum of all a posteriori probabilities of all matching candidates which are on the link (l) in the respective time window (w); preferably wherein the maximum a posteriori probability is determined by using a forward-backward algorithm.

In a sixth aspect according to any one of preceding aspects 1 to 5, determining by using a modified forward algorithm comprises: determining for each link (l) and each time window (w) of a data pair whether the link (l) was safely traveled or could be safely traveled between each two matching candidates of adjacent associated GPS positions within the time window (w); or determining a probability for each link (l) and each time window (w) of a data pair that the link (l) was traveled between each two matching candidates of adjacent associated GPS positions within the time window (w); and determining a probability for each link (l) and each time window (w) of a data pair whether the link (l) was traveled within the time window (w) using observation probabilities and transition probabilities; preferably by using a modified forward algorithm.

In a seventh aspect according to any one of preceding aspects 1 to 6, one or more links of the plurality of links of the network connect one or more nodes of a plurality of nodes of the network to one another. The network preferably maps a traffic network. Furthermore, each of the plurality of links preferably represents a segment of a traffic path and/or each of the plurality of nodes represents an intersection point of traffic paths.

In an eighth aspect according to any one of preceding aspects 1 to 7 in conjunction with aspect 3, each position specification of the plurality of position specifications furthermore contains a GPS heading and determining one or more matching candidates comprises: determining the one or more matching candidates for each position specification in the form of a triple made up of the link (l) of a data pair, a position on the link (l), and a direction along the link (l).

In a ninth aspect according to any one of preceding aspects 1 to 8 in conjunction with aspect 3, the method furthermore comprises: determining an additional matching candidate for each position specification, wherein the additional matching candidate is not located on a link (l) of the plurality of links of the network; an observation probability for the additional matching candidate of each position specification based on a distance of the position specification of the matching candidate; and a transition probability in pairs for the additional matching candidates with respect to the first position specification (P1) and the second position specification (P2), wherein the transition probability is determined from the additional matching candidate of the first position specification to each matching candidate of the second position specification.

In a tenth aspect, a system is specified for determining a map matching confidence. The system comprises a control unit, which is configured to execute the method according to embodiments of the present disclosure, in particular according to any one of preceding aspects 1 to 9.

In an eleventh aspect, a vehicle is specified. The vehicle comprises a system for determining a map matching confidence according to embodiments of the present disclosure, in particular according to preceding aspect 10.

Exemplary embodiments of the disclosure are illustrated in the figures and are described in greater detail hereinafter. The same reference signs are used hereinafter, if not indicated otherwise, for identical and identically acting elements.

### BRIEF DESCRIPTION OF THE DRAWINGS

FIG. 1 schematically shows the structure of a system according to embodiments of the present disclosure.

FIGS. 2 and 3 schematically illustrate, on the basis of a road topology which is divided into multiple links, how a matching of GPS positions to links includes a residual uncertainty.

FIG. 4 schematically illustrates a road which is divided into multiple links.

FIG. 5 schematically illustrates a road having a branch which is divided into multiple links.

FIG. 6 schematically illustrates on the basis of a road which is divided into multiple links how a high confidence for one link can be transferred to other links.

FIG. 7 schematically illustrates on the basis of a road which is divided into multiple links how a confidence for one link is dependent on the number of captured GPS positions.

FIG. 8 shows a flow chart of a method according to embodiments of the present disclosure.

### DETAILED DESCRIPTION OF THE DRAWINGS

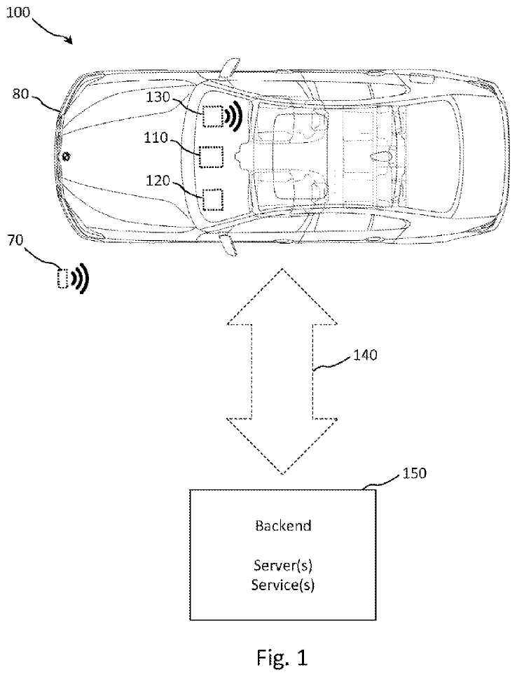

FIG. 1 schematically shows the structure of a system 100 according to embodiments of the present disclosure for use in a vehicle 80. The system can essentially be embodied on a control unit 120 of the vehicle 80 and/or in a backend component 150 (for example, backend server or backend services). The vehicle 80 furthermore comprises, in addition to the control unit 120, a communication unit 130, which is configured for data communication with components (for example mobile terminals 70 and backend 150) external to the vehicle 80, and a user interface 110.

The user interface 110 includes one or more multimodal user interfaces, in particular user interfaces which are configured for the operation of the vehicle 80 (e.g., navigation, infotainment, vehicle settings). The user interface 110 enables the multimodal capture of inputs of a user 60 (not shown in FIG. 1), for example via a graphic user interface (for example touchscreen), via operating elements of the vehicle 80 (e.g., buttons, switches, iDrive controller), via speech control, and the like. The user interface 110 furthermore enables the multimodal output of items of information to a user 60, for example via a graphic display element (e.g., touchscreen, head-up display, instrument cluster, central information display or CID), via tactile elements (for example vibration of the steering wheel or of parts of the seat), via speech output via a loudspeaker system provided in the vehicle (for example infotainment system) or acoustic signal generator (for example gong, beeper), and the like. The user interface 110 can implement a graphic user interface based on corresponding configuration data in which display elements and operating elements are shown which can be used by the user 60 for operating the vehicle 80. Additionally or alternatively, the user interface can include further display and operating elements, for example switches, buttons, and displays.

The control unit 120 can establish data communication with external components and services via the communication unit 130 and thus, for example, communicate with backend servers and/or backend services 150. Alternatively or additionally, the control unit 120 can establish data communication via the communication interface 130 with apps, which are installed, for example, on a mobile terminal 70 of a user 60, and thus accept inputs from the user 60 via the mobile terminal 70 or use applications which are not directly implemented on the control unit or are assisted in another way. A connection to mobile terminals 70 can be established, for example, by common interfaces (e.g., wired, Bluetooth, Wi-Fi).

Furthermore, the system 100 can have a backend component 150 or infrastructure external to the vehicle 80, which provides one or more resources (for example server, services). The backend component 150 can establish data communication 140 temporarily or permanently with the control unit 120 of the vehicle 80. Resource-intensive processing steps can preferably be outsourced to the external backend component 150, which could be performed only with difficulty or not at all by the control unit 120 in the vehicle 80. Possible demands with respect to processing performance, storage performance, available bandwidth, connection to external data sources, and the like can also be taken into consideration here.

In some applications, the use of a backend or the processing by a backend can be disadvantageous for reasons related to data protection laws. One example of this is the personalized learning of events such as the activation of driver assistance or infotainment functions by the driver at identical locations. One example of this would be the use of the so-called “side view” function at a specific intersection or junction. The “side view” function permits a visual capture of the cross traffic at junctions or exits, parking spaces, and the like by the driver by cameras provided in the front of the vehicle, which are laterally oriented. An activation or use of this function permits in particular very accurate locating of junctions or intersections and intersection points.

For such applications, matching the GPS position of the side view activations with mini-trace matching in the vehicle to a link and later establishing using online map matching whether the driver is located on the corresponding link or is driving toward it can be provided.

In the present case, it is presumed that the user is in a vehicle 80 and travels a route which includes a plurality of links, i.e., parts or segments of the route. The application in the vehicle is exemplary here and the presently disclosed systems and methods are possible on any type of navigation, for example on foot, using the bicycle, using public transport, using single-track or multitrack motor vehicles, water vehicles, or aircraft and the like. The user or his vehicle accordingly moves along a GPS trajectory which includes a plurality of GPS positions which are reached via the course of a route. The number of the GPS positions, the intervals or distances between them, and their accuracy can vary. Captured GPS positions are then assigned to one or more links of the route, for which purpose the map matching confidence is relevant.

In addition to assigning GPS positions to links, map matching can also be used to determine the sequence of all links over which a vehicle is driven. This is relevant in particular in the case of GPS trajectories having large chronological/spatial intervals between the GPS positions. In some embodiments, determining the fastest route between individual matchings is therefore provided. This is advantageous in particular if there is such a large interval between GPS positions that the links traveled between them are not necessarily unambiguously determinable. The determination of the fastest (or shortest or optimized according to another criteria) route permits in such cases the link or the links to be determined which were traveled with the greatest probability.

In the context of the present disclosure, it is assumed that additional items of information about features can be provided for one or more links, in particular about hazardous situations or other important events, so that the most precise possible assignment of the features to individual links is necessary. A high reliability of the assignment of a GPS position to one or more links is of interest here in particular. The application with regard to local hazard warning essentially includes two problems. On the one hand, events (for example hazards) recognized by vehicles have to be matched with the correct links. On the other hand, the respective present position of other vehicles has to be matched with the correct links, so that these vehicles can then be warned if necessary of events which are located on their route.

In order that the application functions for predictive hazard warning, at least these two above-mentioned problems have to be solved with sufficient accuracy, wherein the confidence calculation is useful in both problems. This is necessary in particular if possible hazards are not merely to be indicated roughly on a map. In the latter case, accurate locating would not be excessively important, due to the lack of spatial resolution of the map and the subsequent interpretation of the user. In addition, it would be conceivable to calculate an additional probability or confidence that a vehicle will be driven past the hazard point from its present matched position (possibly in consideration of a planned route and the road topology). This additional probability could then be used for further processing of the items of information and finally for the hazard warning. In the case of certain applications, for example if the information is not detected by vehicles, but is already provided with sufficient accuracy in the map in the vehicle (for example, speed camera warning with third-party content), it is possible to concentrate on the second problem (hazard warning).

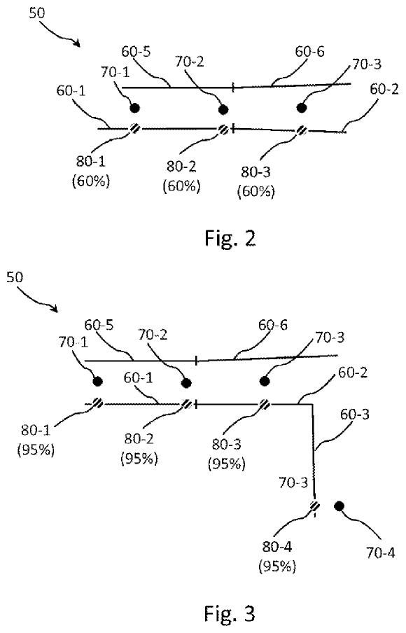

FIGS. 2 and 3 schematically illustrate on the basis of a road topology 50, the roads of which are divided into multiple links 60-1, 60-2, 60-5, 60-6, 60-3 (the latter only in FIG. 3), how a matching of GPS positions 70-1, 70-2, 70-3 to links 60-1, 60-2, 60-5, 60-6, 60-3 (the latter only in FIG. 3) includes a residual uncertainty. FIG. 2 shows a situation in which for all three GPS positions 70-1, 70-2, 70-3 in consideration of the road topology and geometry it cannot be determined with high reliability on which link 60-1, 60-2 or 60-5, 60-6 these are to be matched. As a consequence, the matched positions 80-1, 80-2, 80-3 should have a low map matching confidence, in the example a link confidence of 60% (or 0.6) is specified.

FIG. 3 shows that if this example is expanded by a further GPS position 70-4 and a further matched position 80-4 (bottom right in FIG. 3), the situation then changes for all other GPS positions 70-1, 70-2, 70-3. Since the GPS position 70-4 can be assigned with high probability to a link 60-3 (cf. matched position 80-4), all other GPS positions 70-1, 70-2, 7-3 can also be assigned with high confidence to the matched links 60-1, 60-2 (cf. matched positions 80-1, 80-2, 80-3).

The goal of the map matching confidence is to calculate the probability that for a given GPS trajectory, a link l would be traveled in a given time window w. Since according to this definition the map matching confidence relates to a specific link, this is also referred to hereinafter as the link confidence.

The link l can be, for example, the link which was assigned by the map matching to an event, for example detected black ice (cf. “hazardous situation”). This can take place in that there is a GPS position for the event, which was matched to a link. However, frequently only the timestamp for the occurrence of the event is known and the link of the event has to be determined by the matched link of the adjacent GPS positions and possibly by calculating a route between these links.

The use of a time window w instead of a point in time is reasonable since the confidence for a link can thus be increased in some situations.

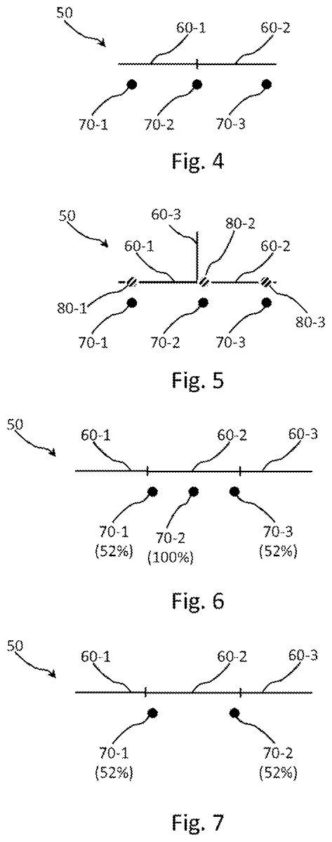

FIG. 4 schematically illustrates a road 50, which is divided into multiple links 60-1, 60-2. Furthermore, the middle GPS position 70-2 is located precisely at the border between two adjacent links 60-1, 60-2. In this case, both links 60-1, 60-2 would have a link confidence of 50% at the point in time of the middle GPS position, since both links come into consideration equally well as candidates. Considered over all three GPS positions 70-1, 70-2, 70-3, however, the link confidence for both links 60-1, 60-2 would be 100%, since both links 60-1, 60-2 were certainly traveled. The links were certainly traveled because only one link comes into consideration for the first and last GPS position (if off-road matches are not taken into consideration, see below). The precise rule for how to calculate the individual confidences is described in greater detail below. The confidences in the examples are first only used for exemplary illustration of the method.

FIG. 5 schematically illustrates a road 50 having a branch which is divided into multiple links 60-1, 60-2, 60-3. GPS positions 70-1, 70-2, 70-3 are illustrated similarly to the GPS positions in FIG. 4. Positions 80-1, 80-2, 80-3 are matched on the links 60-1, 60-2 of the road 50. In some map models, there are only nodes having more than two applied edges, i.e., links can only end at intersections. However, the confidence calculation over time windows can also increase the confidence in certain situations in these map models, as shown in FIG. 5. The link confidence for link 60-2 (right) at the point in time of the middle GPS position is only slightly greater than 50% here. Considered over all three GPS positions 70-1, 70-2, 70-3, the link confidence for link 60-1 (left) and link 60-2 (right) is 100%, however.

There are multiple alternatives for how the selection of the time window can take place.

1. In the case of short GPS trajectories (for example 20 seconds), the entire GPS trajectory can be selected as the time window. In contrast, in the case of long GPS trajectories, the constriction of the time window is reasonable since it is of interest when a link was traveled through.
2. The time window can be defined by the interval between two GPS positions, for example by the time window between the third and the fifth GPS position. If the link confidence is to be calculated for all produced GPS positions, the time window can comprise, for example, in each case k positions before and after the produced GPS position. At the beginning and at the end of the GPS trajectory, the time window then correspondingly contains fewer GPS positions.
3. The time window can be chronologically defined relative to a specific point in time, for example, 5 seconds before to 5 seconds after the recognition of a local hazard. However, this presumes that the GPS positions have timestamps and requires that the position on the road is estimated at the beginning/end of the time window. The position estimation can be carried out by generating further GPS positions at the beginning/end of the time window by interpolation of the adjacent GPS positions. An improved position estimation for beginning or end of the time window is described hereinafter with reference to the second embodiment. However, the improved method is only applicable for the modified forward algorithm.
4. The time window can be determined in that it starts in the matched link at a GPS position and continues from there forward and backward in the GPS trajectory until the link is no longer a candidate. This can also be combined with the two preceding methods in order to additionally delimit the time window.

The presently disclosed algorithm first calculates further data from input data and based thereon the confidence can then be calculated using two alternative approaches (cf. first and second embodiments described hereinafter).

The following are required as input data for the confidence calculation:
The GPS trajectory consisting of n GPS positions. A timestamp and/or a GPS heading can optionally be provided for each GPS position.
A list of <Iᵢ, wᵢ> pairs, wherein 1, are the links for which the link confidence is to be calculated and wᵢ are the associated time windows.

The link confidence is then calculated for all Iᵢ.

In practice, the link confidence is frequently only calculated for the matched links. For the example of the recognition of local hazards, the calculation of the link confidence even only for the matched link of the local hazard would be sufficient.

First, further data are calculated from the input data and from the data of the digital map:
A set of matching candidates is calculated for each GPS position. A candidate is defined (similarly to Newson and Krumm) as the pair <link, position on link>. Candidates can be calculated (similarly to Newson and Krumm) in that the perpendicular from the GPS position is dropped on all links in a surrounding area (for example 100 m). However, it is also possible to generate multiple candidates per link, which increases the map matching accuracy at the expense of the computing effort. The calculation of the link confidence over a time window is more important in this variant, since for each GPS position the overall confidence of 100% would otherwise be divided over even more candidates (see above). The optional calculation of multiple candidates per link represents an expansion over the method of Newson and Krumm.
For all candidates of the GPS position, an observation probability is calculated, for example, in consideration of the distance between GPS position and candidate (similarly to Newson and Krumm). In addition, the heading difference between input heading and heading of the link can be taken into consideration, for example, in that a normal distribution is assumed for the heading difference. This also represents an expansion over the method of Newson and Krumm.
For all candidates of adjacent GPS positions P1 and P2, a transition probability from each candidate of P1 to each candidate of P2 is calculated in pairs, for example, in consideration of the length or time on the shortest or fastest route between both candidates. This can be carried out similarly to Newson and Krumm or in a modified way. Newson and Krumm use an exponential distribution for calculating the transition probabilities. Notwithstanding this, in the map matcher according to the present disclosure, transition probabilities can optionally (additionally) be calculated based on normal distributions. Depending on the data to be matched (accuracy of the GPS positions and time intervals between the GPS positions), the approach can then be optimized in detail. In practice, this can require the parameters of the distribution to be used to be adjusted for the data to be matched. In general, for map matching applications within the hidden Markov model, there is a certain latitude for how accurately transition and observation probabilities are calculated. This latitude can be used accordingly for optimizations.

These data are also needed for an HMM-based map matching algorithm similarly to Newson and Krumm and are calculated by the map matching algorithm. The confidence calculation is carried out after the actual map matching and builds on the described observation and transition probabilities calculated by the map matching algorithm. However, it is also possible to execute the confidence calculation without the map matching algorithm, for example for all candidates.

A first embodiment is based on a maximum a posteriori probability.

Firstly, the a posteriori probabilities of all candidate links Iᵢ are calculated with the aid of the above-described observation and transition probabilities using the forward-backward algorithm. The forward-backward algorithm is described, for example, in Stuart Russell, Peter Norvig: “Artificial Intelligence A Modern Approach 3rd Edition”, Upper Saddle River, N.J., Pearson Education/Prentice-Hall, (2010).

As the initial distribution for the candidates of the first GPS position, it is reasonable to assume a discrete uniform distribution, i.e., each candidate has the same a priori probability. Alternatively, similarly to Newson and Krumm, the observation probabilities for the first GPS distribution can be used as the initial distribution. However, the observation probabilities then also have to be scaled. Both alternatives are mathematically equivalent.

The link confidence Iᵢ for the time window wᵢ then results from the maximum of the a posteriori probabilities over all candidates which are on the link Iᵢ in the time window wᵢ.

FIG. 6 schematically illustrates on the basis of a road 50, which is divided into multiple links 60-1, 60-2, 60-3, how a high confidence for a link 60-2 can be transferred to other links 60-1 and 60-3. The use of the forward-backward algorithm enables all GPS positions of the entire GPS trajectory to be incorporated into the calculation of the a posteriori probabilities. Therefore, as shown in FIG. 6, a high confidence for one link, in the example link 60-2, can also be transferred to other links, in the example 60-1 and 60-3.

In the example illustrated in FIG. 6, the time window w comprises all three GPS positions 70-1, 70-2, 70-3 and the link confidence for the second link 60-2 is max {0.52, 1, 0.52}=1 (or 100%). For example, if an event was recognized at the first GPS position 70-1, this event can be located with a confidence of 100% at the beginning of the second link 60-2. This is based on the fact that the second link 60-2 was traversed with a probability of 100% in the time window w, even if it is only 52% certain that this occurred precisely at the point in time of the first GPS position 70-1.

FIG. 7 schematically illustrates on the basis of a road 50 which is divided into multiple links 60-1, 60-2, 60-3 how a confidence for a link 60-2 is dependent on the number of captured GPS positions. The approach of the first embodiment, based on a maximum a posteriori probability, functions well if there are multiple GPS positions (in the example 70-1, 70-2, and 70-3) per link (in the example 60-2). In the case of GPS trajectories having large chronological or spatial intervals between the GPS positions, the problem exists that the confidence can undesirably be reduced at GPS positions in the vicinity of nodes. The link confidence for the second link 60-2 in the example illustrated in FIG. 7 is thus only 52%, although the second link 60-2 was certainly traversed.

Methods and systems according to the above-described first embodiment provide advantages, also in comparison to the second embodiment described hereinafter, with respect to particularly efficient calculation, in particular if a large number of link confidences is to be calculated for a GPS trajectory.

A second embodiment is based on a modified forward algorithm. The second embodiment enables advantages in comparison to the first embodiment with respect to the precision of the calculations, in particular in the case of GPS trajectories having large chronological or spatial intervals between the GPS positions.

According to the second embodiment, the link confidence c(l;w) is calculated for a link l and a time window w using a modified form of the forward algorithm. The following definitions apply for this purpose:
t=1 . . . n is the progressively numbered GPS position (=the time step)
xₜ is the state (hidden state) in the time state t. All candidates come into consideration for this time step as the state (see chapter 3).
yₜ is the observation, i.e., the GPS position and possibly the vehicle heading, in the time step t.
The random variable Lᵢ^{j} is the set of the links which were traversed between time step i and time step j. This also includes the links between the respective candidates which can have been determined, for example, by shortest or fastest routes between the candidates.
The time window is defined in the following as w=(s;e), wherein s is the first and e is the last position of the time window. The case is considered hereinafter that the time window is defined relative to a specific point in time, for example, 5 seconds before to 5 seconds after the recognition of an event.

The link confidence c(l;w) is defined as the probability that the link l was traversed in the time window w=(s;e), given all GPS positions of the trajectory:

c(l,w)=p(l∈Lₛ^{e}|y_{1:n}). (1)

In principle, c(l;w) is calculated over the counter probability:

αₜ(xₜ)=p(xₜ,l∉L₁^{t},y_{1:t}). (2)

For the further derivation of the calculation, we first consider the case that the time window w comprises the entire GPS trajectory, i.e., w=(0;n). The general case w=(s;e) is discussed hereinafter.

Similarly to the forward algorithm, the modified forward algorithm iteratively calculates the probability (joint probability) for each time step t=1 . . . n and each candidate xₜ of the respective time step

αₜ(xₜ)=p(xₜ,l∉L₁^{t},y_{1:t}). (3)

This is to be the probability in the time step t in the state xₜ not to have traversed the link l up to the time step t and to have observed the recorded GPS positions up to the time step t.

The calculation of αₜ(xₜ) can be carried out iteratively according to the following derivation: The following results from equation (3) according to the law of total probability:

$${α}_{t} ( {x}_{t} ) = {\sum }_{{x}_{t - 1}} p ( {x}_{t} , l ∉ {L}_{1}^{t} , {x}_{t - 1} , {y}_{1 : t} ) . \qquad ( 4 )$$

The following results by application of the chain rule (note: the formula is read from bottom to top here)

$${α}_{t} ( {x}_{t} ) = {\sum }_{{x}_{t - 1}} p ( {y}_{t} \vert {x}_{t} , {x}_{t - 1} , l ∉ {L}_{1}^{t} , {y}_{1 : t - 1} ) \\ p ( l ∉ {L}_{t - 1}^{t} \vert {x}_{t} , {x}_{t - 1} , l ∉ {L}_{1}^{t - 1} , {y}_{1 : t - 1} ) \\ p ( {x}_{t} \vert {x}_{t - 1} , l ∉ {L}_{1}^{t - 1} , {y}_{1 : t - 1} ) \\ p ( {x}_{t - 1} , l ∉ {L}_{1}^{t - 1} , {y}_{1 : t - 1} ) \qquad ( 5 )$$

This corresponds to the application of the chain rule to derive the forward algorithm with the additional condition that the link l was not traversed up to the time step t.

To simplify the above formula, we use the HMM assumptions that yₜ is only dependent on xₜ and xₜ is only dependent on xₜ₋₁. Furthermore, we assume that

p(l∉Lₜ₋₁^{t}|xₜ,xₜ₋₁,l∉L₁^{l-1},y_{1:t-1})=p(l∉Lₜ₋₁^{t}|xₜ,xₜ₋₁),

i.e., whether the link l was traversed from xₜ₋₁ to xₜ, is independent of whether l was previously traversed and which GPS positions were previously observed. It follows from these assumptions that

$${α}_{t} ( {x}_{t} ) = p ( {y}_{t} \vert {x}_{t} ) {\sum }_{{x}_{t - 1}} p ( l ∉ {L}_{t - 1}^{t} \vert {x}_{t} , {x}_{t - 1} ) p ( {x}_{t} \vert {x}_{t - 1} ) {α}_{t - 1} ( {x}_{t - 1} ) . \qquad ( 6 )$$

In this case, p(yₜ|xₜ) are the observation probabilities and p(xₜ|xₜ₋₁) are the transition probabilities which were previously calculated by the map matching algorithm or independently (as described above).

Furthermore, p(l∉Lₜ₋₁^{t}|xₜ, xₜ₋₁) is the probability that l was not traveled between xₜ₋₁ and xₜ. This probability can be calculated as follows, wherein for reasons of readability, the counter probability p(l∉Lₜ₋₁^{t}|xₜ, xₜ₋₁)=1−p(l∉Lₜ₋₁^{t}|xₜ, xₜ₋₁) is used.

$$p ( l ∈ {L}_{t - 1}^{t} \vert {x}_{t} , {x}_{t - 1} ) = \{ \begin{matrix}1 , & if l is on the shortest / fastest route from {x}_{t - 1} to {x}_{t} \\ 0 , & otherwise\end{matrix} \qquad ( 7 )$$

It is to be noted here that the actual path between xₜ₋₁ and xₜ is not known and the use of the shortest/fastest route between the candidates results in an approximation of the link confidence. Therefore, a conservative calculation of the link confidence by a lower barrier is more reasonable for some applications. This can be calculated as follows:

$$p ( l ∈ {L}_{t - 1}^{t} \vert {x}_{t} , {x}_{t - 1} ) = \{ \begin{matrix}1 , & if all routes there are from {x}_{t - 1} to {x}_{t} lead through l \\ 0 , & otherwise\end{matrix} \qquad ( 8 )$$

It can additionally be taken into consideration which routes between xₜ₋₁ to xₜ are possible at all with an assumed highest speed.

A lower barrier which is easier to calculate but is less strict is

$$p ( l ∈ {L}_{t - 1}^{t} \vert {x}_{t} , {x}_{t - 1} ) = \{ \begin{matrix}1 , & if {x}_{t - 1} or {x}_{t} is on l \\ 0 , & otherwise\end{matrix} \qquad ( 9 )$$

A further possibility is to determine the probability from GPS trajectories of historic trips, i.e., p(l∈Lₜ₋₁^{t}|xₜ, xₜ₋₁) results from

$$\frac{ \begin{matrix}Number of the trips via {x}_{t - 1} and \\ {x}_{t} in which link l was traversed\end{matrix}}{Number of the trips via {x}_{t - 1} and {x}_{t}} \qquad ( 10 )$$

The starting values α₁(x₁) can be calculated as follows according to equation (3). The x₁ can be assumed to be uniformly distributed (cf. also the first embodiment).

α₁(x₁)=p(x₁,l∉L₁¹,y₁)=p(l∉L₁¹|x₁)p(y₁|x₁)p(x₁) (11)

The link confidence for the time window w₀=(l;n) then results from

$$c ( l , {w}_{0} ) = 1 - p ( l ∉ {L}_{1}^{n} \vert {y}_{1 : n} ) = 1 - \frac{{\sum }_{{x}_{n}} {α}_{n} ( {x}_{n} )}{p ( {y}_{1 : n} )} . \qquad ( 12 )$$

The calculation of p(y_{1:n}) can be carried out by the normal forward algorithm and only has to be carried out once during the calculation of multiple link confidences.

With regard to the numerical stability in the calculation, it is to be noted that α₁(x₁) become very small with increasing iterations. One alternative is therefore to work with logarithmic probabilities. Another alternative is to calculate p(xₜl∉L₁^{t}|y_{1:t}) in each step. Although the calculation of p(y_{1:n}) is thus finally omitted, this represents a higher level of computing effort.

The calculation of the link confidence for general time windows w=(s;e) is described hereinafter, wherein s is the first and e is the last GPS position of the time window. This covers the second and the fourth definition of time windows (see above).

The calculation takes place in 3 phases, one phase each before, during, and after the time window. It only has to be checked in the phase during the time window whether the link l was traversed. The results of a phase are used as starting values for the next phase. In the first phase, αₛ(xₛ)=p(xₛ, y_{1:s}) are calculated using the normal forward algorithm. In the second phase, αₑ(xₑ)=p(xₑ, l∉Lₛ^{e}|y_{1:e}) are calculated using the above-described modified forward algorithm. Finally, in the third phase, αₙ(xₙ)=p(xₙ, l∉Lₛ^{e}|y_{1:n}) are again calculated using the normal forward algorithm. The link confidence c(l;w) then results similarly to equation (12) from

$$c ( l , w ) = 1 - p ( l ∉ {L}_{s}^{e} \vert {y}_{1 : n} ) = 1 - \frac{{\sum }_{{x}_{n}} {α}_{n} ( {x}_{n} )}{p ( {y}_{1 : n} )} . \qquad ( 13 )$$

In the calculation of m link confidences having different time windows w₁=(s₁;e₁), . . . , wₘ=(sₘ;eₘ), the first phase only has to be calculated once for all time windows. In this case, α₁(x₁) are calculated for t=1, . . . , max(s₁, . . . , sₘ) using the normal forward algorithm.

For the case that the time window is defined relative to a certain point in time, for example, 5 seconds before to 5 seconds after the recognition of an event (see above, third definition of time windows), the calculation of p(l∉Lₜ₋₁^{t}|xₜ, xₜ₋₁) thus has to be adapted for the cases in which beginning/end of the time window is between xₜ₋₁ and xₜ. Equations (7), (8), and (10) can thus be adapted in that the position at the beginning/end of the time window is estimated along the shortest/fastest route (7), the possible routes (8), and along the historic trips (10). In the conservative estimation of the confidence in equation (9), in contrast, it is checked either for xₜ or xₜ₋₁ (depending on which state is in the time window) whether they are on the link l.

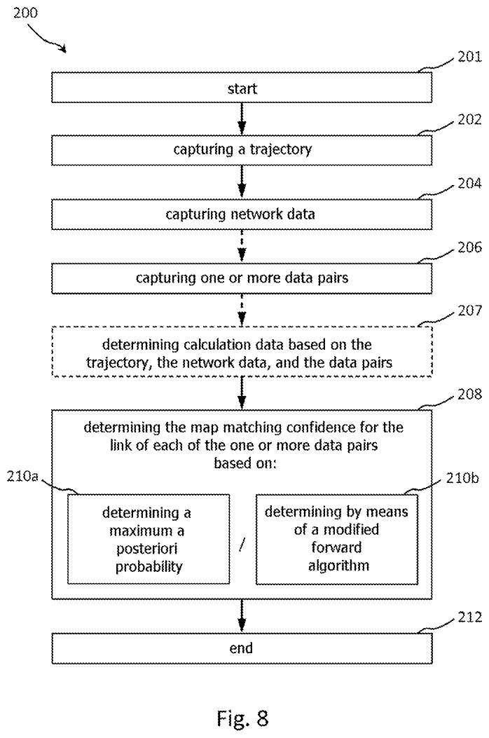

FIG. 8 shows a flow chart of a method 200 according to embodiments of the present disclosure. The method 200 begins at step 201.

A trajectory is captured in step 202. The trajectory preferably contains a plurality of position specifications, wherein each position specification of the plurality of position specifications furthermore preferably includes a GPS position (e.g., 70-1, 70-2, 70-3; see figures) and a timestamp.

In step 204, network data containing a plurality of links of a network are captured. A network preferably consists of a plurality of links l (e.g., 60-1, 60-2, 60-3; see figures), which connect a plurality of nodes to one another. The network can be modeled in a known way as a graph (see above).

One or more data pairs are captured in step 206. Each of the one or more data pairs contains a link l from the plurality of links and a time window w which captures at least a part of the trajectory. The capture of the trajectory takes place chronologically, so that at least one, preferably multiple position data of the trajectory have to be within the time window w (i.e., were captured within the time window w).

In step 208, a map matching confidence c(l,w) for the link l of the respective data pair is determined for each of the one or more data pairs. This is based either on determining (cf. step 210a; description see above) a maximum a posteriori probability or determining (cf. step 210b; description see above) by using a modified forward algorithm. The map matching confidence is configured to specify a probability that the trajectory was tangent to the respective link l within the respective time window w. The method 200 ends at step 212.

The presently disclosed systems and methods for confidence calculation can be applied in principle in cooperation with arbitrary algorithms (also not HMM-based), since a confidence is to be calculated independently of the algorithm used. Even if an HMM is used, various algorithms are possible, for example the Viterbi algorithm (cf. Newson and Krumm), the forward-backward algorithm, or the forward algorithm. The forward algorithm is also described, for example, in Russell and Norvig (see above). The method for calculating the map matching confidence may also be applied to map matching methods which calculate corresponding scores (or assessments) instead of observation and transition probabilities, which may be scaled to values between 0 and 1 (for example pseudo-probabilities).

It is also possible to use the confidence calculation without a map matching algorithm, for example for all candidates of all GPS positions within a time window. The link l is then selected for which the link confidence is greatest. In the example of the recognition of local hazards, the candidate having the greatest confidence would thus be selected. In map matching, in principle a candidate could also be selected which is not on the link l and therefore has a lower confidence than link l. This method therefore has the advantage that the highest possible confidence is always achieved.

In preferred embodiments, the link direction can be considered. The link direction can be considered in the definition of the map matching confidence, i.e., the link confidence is defined as the probability that a link l was traveled in a direction within a time window w for a given GPS trajectory. This modeling is reasonable if the direction in which a link was traveled is important. The link direction is thus relevant for some local hazards (for example hazardous end of a traffic jam), but not for others (for example, strong rain or fog).

To take the link direction into consideration for the confidence calculation, a candidate has to be generated for each possible traversal direction of a link during the generation of candidates. A candidate is then defined as a triple as described above <link ID, position on link, direction>. The further calculation of the link confidence by the above-described forward-backward or modified forward algorithm does not change, however, except for the fact that the number of the candidates is increased by the consideration of the direction.

The consideration of the link direction is also applicable for the map matching itself. In the map matching, this modeling has the additional advantage that penalties for U-turns or similar maneuvers on a link can be taken into consideration by reduced transition probabilities. Incorporating the direction for the map matching represents an expansion over the disclosure of Newson and Krumm.

In preferred embodiments, the calculation of a confidence for online map matching is provided. In online map matching, the GPS positions of a vehicle are processed continuously and essentially simultaneously with the input (for example as a stream or datastream of GPS positions). This means that every incoming GPS position is processed essentially immediately without knowledge of following GPS positions. Applying the forward algorithm or the Viterbi algorithm up to the last input or present GPS position for the online map matching suggests itself. If the Viterbi algorithm is used for online map matching, it has to be noted that the most probable path for past GPS positions can change due to the additional information of further GPS positions. “Jumps” or subsequently changing data can thus occur.

The link confidence can also be calculated online to calculate a confidence for the present matching. In the case of the approach via the maximum a posteriori probability (cf. first embodiment), the forward algorithm is used instead of the forward-backward algorithm. The link confidence lᵢ for the time window wᵢ then results from the maximum of the a posteriori probabilities over all candidates which are on the link lᵢ in the time window wᵢ. It is to be noted that the time window cannot include future GPS positions, and that the a posteriori probabilities represent the results of the forward algorithm instead of the forward-backward algorithm.

The modified forward algorithm (cf. second embodiment) can also be used in principle for an online confidence calculation. The first phase can be progressively calculated. Since the links are normally not yet known for which the link confidence is to be calculated (these are determined by online map matching), the second phase has to be executed again at each further GPS position over the length of the time window (unless the link made remains the same). This can mean a significant computing effort in the case of larger time windows. The third phase is omitted, since the time window only extends up to the present GPS position and future GPS positions are not known.

In preferred embodiments, a further subdivision of the links into segments can be carried out, if it is to be calculated for a smaller road section whether the vehicle has traveled it. This could be used, for example, in the case of local hazard warnings to decide whether the local hazard is located on a limited road section, for example on an intersection or within a tunnel. A hazard warning could thus be made even more precise with respect to location.

In preferred embodiments, an acceleration of the confidence calculation can be provided. If only one or a few link confidences are to be calculated for a longer GPS trajectory (for example 1 hour), the confidence calculation can thus be accelerated in that only a part of the entire GPS trajectory is processed for each link confidence to be calculated, while the remaining GPS positions are discarded (this corresponds to the above-described mini-trace map matching). The processed part of the GPS trajectory can then essentially contain the time window and optionally still further GPS positions before and/or after the time window. Since GPS positions which are far away from an event have no or only a minor influence on the link confidence for the matched link of the event, the calculated confidence becomes only slightly or not at all less accurate. The confidence for a link in the downtown region of a city is thus independent of GPS positions which were recorded during the same trip outside the city. This method is applicable for both approaches according to the first and second embodiments for confidence calculation.

Furthermore, in general, for example, the distance to the matched link could be used for the purpose of a plausibility check for the map matching. The matching for a determined position can thus be discarded if the distance of the matched position to the original position is greater than a determined value, for example 10 m. In the same way, the matched heading (i.e., the orientation or direction) can be checked for plausibility using the vehicle heading (for example maximum absolute heading difference=90°).

In some embodiments, the confidence calculation can be expanded to so-called off-road matches, which do not have to be positioned on links present in the map data, but can be located away from a road, therefore “off-road” (cf. DE 10 2017 213 983). The principle of off-road matches is to expand the set of candidates to a GPS position by one off-road candidate in each case. The calculation of the observation and transition probabilities in terms of the confidence calculation then has to be expanded accordingly for off-road candidates. In particular, at least the following cases have to be taken into consideration in addition for the calculation of the transition probabilities: on-road to off-road, off-road to off-road, and off-road to on-road. A corresponding adaptation of the confidence calculation follows the specific modeling of the off-road matches and the underlying calculation rules.

One advantage of these plausibility checks is that errors in the digital map can thus be recognized. For example, if a newly constructed road is not yet recorded in the digital map, this can be recognized via the distance of the matched position to the original position. However, these plausibility checks only take into consideration the GPS position and the matched link, i.e., further links are not taken into consideration.

Although the invention was illustrated and explained in greater detail by preferred exemplary embodiments, the invention is not thus restricted by the disclosed examples and other variations can be derived therefrom by a person skilled in the art without leaving the scope of protection of the invention. It is therefore clear that a variety of possible variations exist. It is also clear that embodiments mentioned as examples actually only represent examples, which are not to be interpreted in any way as a restriction of for example, the scope of protection, the possible applications, or the configuration of the invention. Rather, the preceding description and the description of the figures make a person skilled in the art capable of specifically implementing the exemplary embodiments, wherein a person skilled in the art aware of the disclosed concept of the invention can perform a variety of changes, for example, with respect to the function or the arrangement of individual elements mentioned in an exemplary embodiment without leaving the scope of protections defined by the claims and their legal equivalents, such as more extensive explanations in the description.

1.-11. (canceled)

12. A method for determining a map matching confidence, the method comprising:
capturing a trajectory;
capturing network data comprising a plurality of links of a network;
capturing one or more data pairs, wherein each data pair of the one or more data pairs comprises:
a link from the plurality of links; and
a time window which captures at least a part of the trajectory; and
determining, for each data pair of the one or more data pairs, a map matching confidence for the link of the respective data pair by:
determining a maximum a posteriori probability; or
using a modified forward algorithm, wherein the map matching confidence is configured to specify a probability that the trajectory was tangent to the respective link within the respective time window.

13. The method according to claim 12, wherein the trajectory contains a plurality of position specifications, and each position specification of the plurality of position specifications comprises: a GPS position and a timestamp.

14. The method according to claim 13, further comprising determining:
one or more matching candidates for each position specification;
an observation probability for each of the one or more matching candidates of each position specification based on a distance of the position specification from the link of the matching candidates; and
a transition probability in pairs for each of the one or more matching candidates with respect to a first position specification and a second position specification adjacent to the first position specification, wherein the transition probability is determined from each matching candidate of the first position specification to each matching candidate of the second position specification.

15. The method according to claim 14, wherein the one or more matching candidates for each position specification comprises a pair made up of the link of a data pair and a position on the link.

16. The method according to claim 13, further comprising determining each time window of the one or more data pairs based on:
the entire trajectory, if the trajectory does not exceed a predetermined duration;
an interval between n position specifications before and k position specifications after a reference position specification;
a time interval before and after a reference position specification; or
a ratio between a position specification and the corresponding link of the respective data pair, wherein the ratio of the position specification to the corresponding link is defined in that the corresponding link is a candidate for the position specification.

17. The method according to claim 16, wherein the predetermined duration is less than 60 seconds.

18. The method according to claim 16, wherein the time interval is less than 30 seconds.

19. The method according to claim 16, wherein n and k are less than 10.

20. The method according to claim 14, wherein determining the maximum a posteriori probability comprises:
determining a respective a posteriori probability for each link of a data pair based on the respective observation probability and the respective transition probability; and
determining the maximum a posteriori probability based on the maximum of all a posteriori probabilities of all matching candidates which are in the respective time window on the link.

21. The method according to claim 20, wherein the maximum a posteriori probability is determined by using a forward-backward algorithm.

22. The method according to claim 12, wherein determining by using the modified forward algorithm comprises:
determining for each link and each time window of a data pair whether the link was safely traveled or could be traveled between each two matching candidates of adjacent associated GPS positions within the time window; or
determining a probability for each link and each time window of a data pair that the link was traveled between each two matching candidates of adjacent associated GPS positions within the time window; and
determining a probability for each link and each time window of a data pair of whether the link was traveled within the time window using observation probabilities and transition probabilities.

23. The method according to claim 12, wherein one or more links of the plurality of links of the network connect one or more nodes of a plurality of nodes of the network to one another.

24. The method according to claim 23, wherein the network maps a traffic network.

25. The method according to claim 24, wherein at least one of:
each of the plurality of links represents a segment of a traffic path or
each of the plurality of nodes represents an intersection point of traffic paths.

26. The method according to claim 14, wherein:
each position specification of the plurality of position specifications further comprises a GPS heading, and
determining one or more matching candidates comprises determining the one or more matching candidates for each position specification in the form of a triple made up of the link of a data pair, a position on the link, and a direction along the link.

27. The method according to claim 14, further comprising determining:
an additional matching candidate for each position specification, wherein the additional matching candidate is not located on the link of the plurality of links of the network;
an observation probability for the additional matching candidates of each position specification based on a distance of the position specification of the matching candidates; and
a transition probability in pairs for the additional matching candidates with respect to the first position specification and the second position specification, wherein the transition probability is determined of the additional matching candidate from the first position specification to each matching candidate from the second position specification.

28. A system for determining a map matching confidence, the system comprising a control unit which is configured to execute a method comprising:
capturing a trajectory;
capturing network data comprising a plurality of links of a network;
capturing one or more data pairs, wherein each data pair of the one or more data pairs comprises:
a link from the plurality of links; and
a time window which captures at least a part of the trajectory; and
determining, for each data pair of the one or more data pairs, a map matching confidence for the link of the respective data pair by:
determining a maximum a posteriori probability; or
using a modified forward algorithm, wherein the map matching confidence is configured to specify a probability that the trajectory was tangent to the respective link within the respective time window.

29. A vehicle comprising a system for determining a map matching confidence according to claim 28.
